(19) United States
(12) Patent Application Publication
(10) Pub. No.: US 2024/0298771 A1
(43) Pub. Date: Sep. 12, 2024

(54) HAIR DRYER WITH MAINTENANCE SIGNALING SYSTEM

(71) Applicant: GAMMA PIU' S.R.L., Cazzago San Martino (IT)

(72) Inventor: Paolo STERZI, Cazzago San Martino (IT)

(73) Assignee: GAMMA PIU' S.R.L., Cazzago San Martino (IT)

(21) Appl. No.: 18/423,223

(22) Filed: Jan. 25, 2024

(30) Foreign Application Priority Data
Mar. 9, 2023 (IT) 102023000004368

(51) Int. Cl. A45D 20/12

(52) U.S. Cl. CPC A45D 20/12

(57) ABSTRACT

The hair dryer includes an internally hollow body which houses an air inlet filter, an air flow generation unit, and a heating element. The hair dryer includes a maintenance signaling system having a control unit which manages an activator for activating a warning to notify the user in advance when cleaning and/or replacing the air inlet filter is required.

### CROSS-REFERENCE TO RELATED APPLICATION

This application claims the benefit of priority to Application No. 102023000004368, filed Mar. 9, 2023, in Italy, and which application is incorporated herein by reference. To the extend appropriate, a claim of priority is made to the above-disclosed application.

### FIELD OF THE INVENTION

The present invention relates to a hair dryer provided with a maintenance signaling system which notifies the user when the hair dryer requires maintenance linked to the cleaning of the filter.

In particular, the present invention belongs to the field of professional hair dryers used in hairdressing salons. However, such an invention is generally applicable to any hair dryer.

A typical issue linked to the intensive use of hair dryers is related to the obstruction of the incoming air filter, which obstruction is due to dust, impurities and particles present in the air. The accumulation of these elements causes a reduction in the inflow of air into the hair dryer, resulting in an overheating thereof. When the overheating is excessive, the device switches off autonomously for safety reasons and remains blocked until the internal components have adequately cooled down. This determines an unsafe condition of use for both the user and the customer subjected to hair drying. In fact, the emergency switch-off condition of the device is not predictable a priori and could occur just as the user is drying a customer's hair. In this case, the user is forced to stop while the job is not finished and the customer is forced to wait for the resolution of the issue.

### PRIOR ART

In the prior art, hair dryers provided with systems for controlling the heat produced by the heating elements inside the hair dryer to prevent an excessive overheating thereof are known. Generally, these are closed-loop control systems which constantly monitor the heat produced by the heating elements so as to compensate for any excesses by self-adjustment. This type of self-adjusting system provides for the implementation of a complex electronic data acquisition and processing system which involves a considerable increase in costs and production times.

It is an object of the present invention to provide a hair dryer which solves the issues of the prior art taking into account the field needs.

### BRIEF DESCRIPTION OF THE DRAWINGS

Such an object is achieved by a hair dryer according to claim 1. The dependent claims describe preferred embodiments of the invention. Further features and advantages of the hair dryer according to the invention will become apparent from the following description, given by way of a non-limiting example, according to the accompanying drawings, in which:

FIG. 1 shows a side view of a hair dryer according to the present invention, in a preferred embodiment;

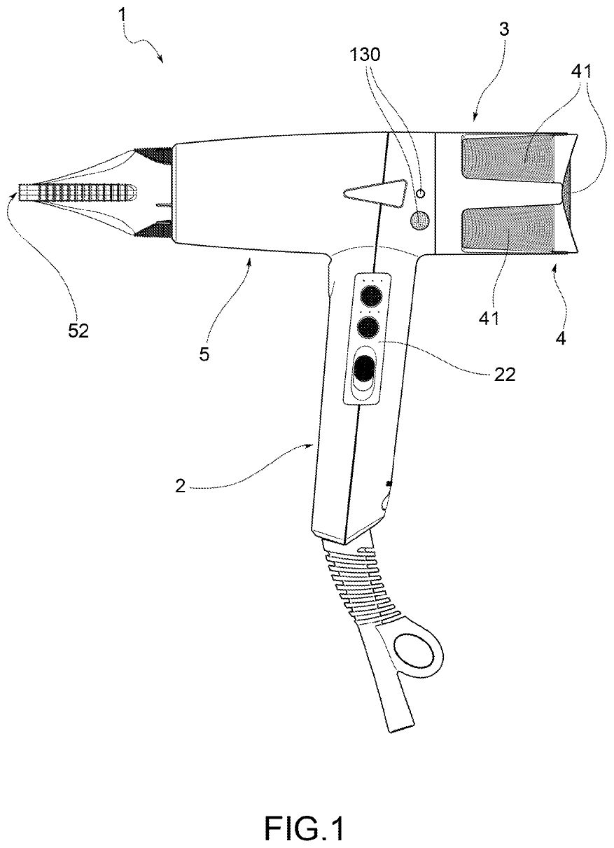

FIG. 2 shows a schematic view of the hair dryer in FIG. 1, in which the external shell has been partially removed;

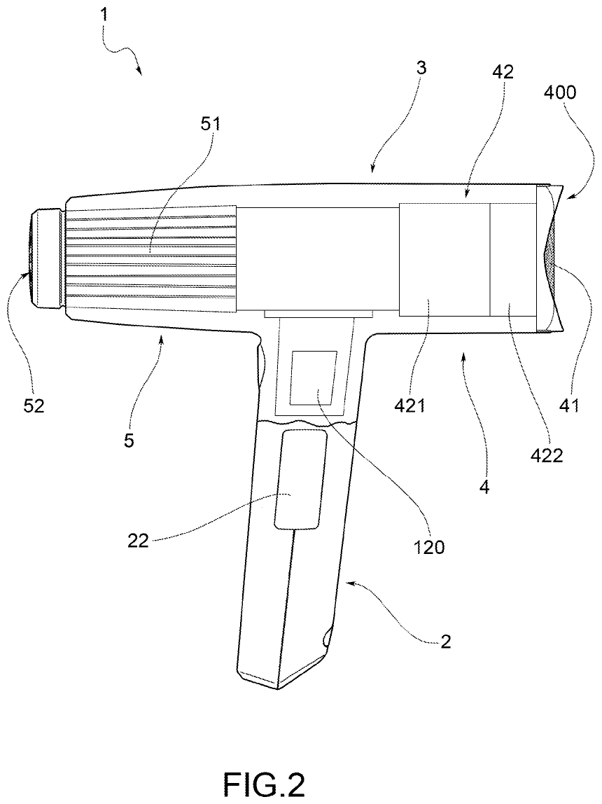

FIG. 3 shows a schematic view of the internal components of the hair dryer in FIG. 1.

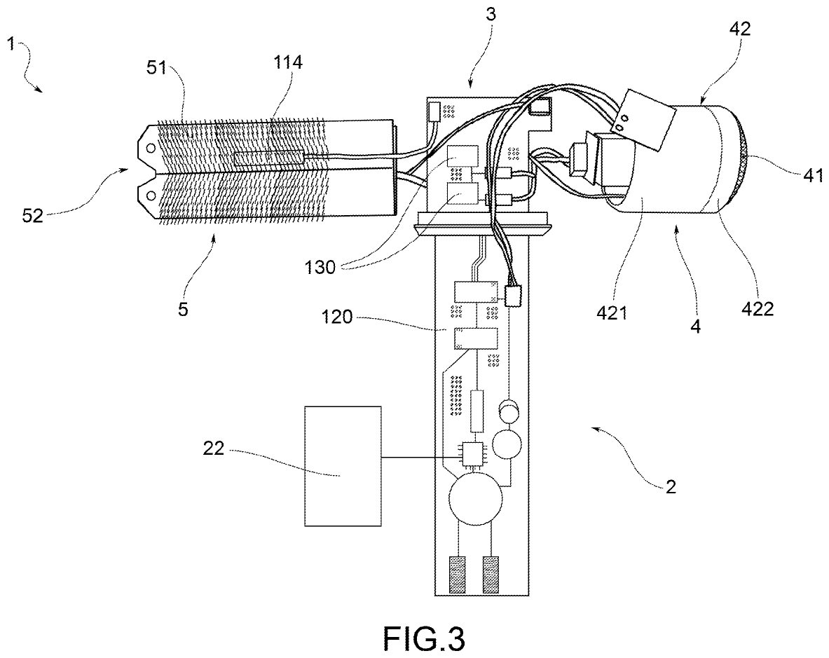

### DETAILED DESCRIPTION OF THE INVENTION

With reference to the accompanying figures, reference numeral 1 indicates as a whole a hair dryer according to the present invention.

The hair dryer 1 comprises an internally hollow body provided with a handle 2 suitable for supporting a transverse portion 3 in which the mechanical and electrical means required for the operation of the device are housed.

The handle 2 houses the power supply means 21 of the device and a user interface 22 for switching on and/or off the hair dryer, and/or for adjusting the temperature of the air flow exiting from the hair dryer, and/or for adjusting the speed of the air flow exiting from the hair dryer.

According to an embodiment, the power supply means 21 comprise a power supply cable (not shown in the figures) having an upper end connected to the handle 2 and a lower end connected to a plug for the connection with an electrical power socket.

According to a further embodiment, the power supply means 21 comprise a power supply battery (not shown in the figures) housed in an appropriate housing compartment 211 obtained in the handle 2.

Preferably, the user interface 22 comprises a plurality of buttons 221, or a touchscreen 222, or a combination of buttons 221 and touchscreen 222.

The transverse portion 3 of the body of the hair dryer is provided with a rear portion 4 and an opposite front portion 5. An air inlet filter 41 is positioned at the rear portion 4, arranged in an appropriate filter seat 400. The filter is suitable for filtering the incoming air from dust, impurities and particles present in the space in which the hair dryer 1 is used.

According to a first embodiment, there is at least one rear inlet filter 41.

According to a second embodiment, there is at least one side inlet filter 41, suitable for filtering the incoming air following a radial suction.

According to a third embodiment, both a rear inlet filter 41 and a side inlet filter 41 are present.

An air flow generation group 42 is housed inside the rear portion 4. Such a group comprises a mechanical energy generation device 421, e.g., an electric motor, intended to power an air flow generation device 422, e.g., a fan, suitable for directing the air flow towards the outlet provided in the front portion 5 of the hair dryer.

According to an embodiment, the mechanical energy generation device 421 is mechanically connected to the air flow generation device 422. The air flow generation device 422 generates, by a centrifugal movement, the air flow flowing inside the transverse portion 3.

At least one heating element 51, arranged upstream of a hot air outlet mouth 52, is housed inside the front portion 5.

The heating element 51 dissipates heat such as to heat the air passing therein and is directed towards the outlet of the hair dryer 1. The heating element 51 is a resistor or an inductor, for example.

As anticipated above, the user interface 22 allows the user to enter the desired settings for adjusting the hair dryer 1, for example the heat level or the air flow speed.

According to the present invention, the hair dryer 1 also comprises a maintenance signaling system 100 comprising activation means 110 for activating warning means 130, both said means being connected to a control unit 120 preferably housed in the handle 2.

The warning means 130 are visual means and/or sound means which produce a visual and/or sound signal when a maintenance operation to clean and/or replace the inlet filter 41 of the hair dryer 1 is required. In other words, the maintenance signaling system 100 comprises warning means 130 to attract the attention of the user and notify the need to carry out a maintenance operation on the inlet filter 41.

According to a preferred embodiment, the warning means 130 comprise at least one LED, visible from outside the hair dryer, which switches on when the filter needs to be cleaned, so that for the user it is very intuitive to know when to carry out maintenance.

According to an embodiment, the activation means 110 comprise a time counter 112 suitable for measuring a predefined time interval. The time counter 112 is preferably positioned close to the control unit 120, to which it is electrically connected. Furthermore, the time counter 112 is controlled by the control unit 120 which determines the start, stop and reset thereof.

According to a further embodiment, the activation means 110 comprise a temperature sensor 114, preferably positioned in the front portion 5, close to the heating element 51, so as to detect the temperature of the heated air flow. The control unit 120 is suitable for receiving the information associated with the temperature of the heated air flow and, depending on the desired settings, to implement a maintenance signaling algorithm for activating the warning means 130. In an embodiment, the temperature sensor 114 is a negative temperature coefficient (NTC) temperature sensor. This is a resistor with a negative temperature coefficient, which means that the resistance decreases as the temperature increases.

According to a further embodiment, the activation means 110 comprise a current sensor 116 suitable for measuring the current absorbed by the mechanical energy generation device 421, e.g., an electric motor. The current sensor 116 is preferably positioned close to the control unit 120, to which it is electrically connected. The control unit 120 is suitable for receiving the information associated with the current absorbed by the electric motor 421 to calculate the power absorbed by the motor and, depending on the desired settings, to implement a maintenance signaling algorithm for activating the warning means 130.

In a first example, the maintenance signaling algorithm is based on an operating time condition: the actuation of the warning means 130 occurs after a predetermined operating time interval of the hair dryer 1.

The first maintenance signaling algorithm comprises the following steps:
setting a maximum time interval, beyond which the operation of the hair dryer 1 is compromised due to the inlet filter 41 being too dirty;
the first time the hair dryer 1 is switched on, starting the time counter 112 and starting the count of the operating time interval; preferably, when the hair dryer 1 is switched off, switching off the time counter to suspend the count of the operating time interval and switching on the time counter again when the hair dryer is switched on again to resume the count of the operating time interval;
when the operating time interval reaches the maximum time interval, activating the warning means 130 to notify the user of the need to clean and/or replace the inlet filter 41.

The duration of the maximum time interval is estimated based on the operation of a conventional professional hair dryer. Preferably, the maximum time interval is between 20 and 30 hours, for example of 25 hours.

In a second example, the maintenance signaling algorithm is based on a maximum internal air temperature value. In such an example, the temperature sensor 114 monitors the temperature of the heated air flow, detecting the value thereof and sending it to the control unit 120. Generally, in fact, there is a rise in the temperature of the heated air flow when the inlet filter 41 is dirty. Preferably, the maximum internal air temperature value must be exceeded continuously over a certain time interval before the warning means 130 are activated. For example, the maximum internal temperature value is set according to the voltage and power supply of the hair dryer 1.

The second maintenance signaling algorithm comprises the following steps:
setting a maximum internal air temperature value, above which there would be an excessive overheating of the hair dryer 1;
detecting, by the temperature sensor 114, the internal temperature of the air heated by the heating element 51;
when the internal air temperature measured by the temperature sensor 114 is greater than the maximum internal air temperature value, activating the warning means 130 to notify the user of the need to clean and/or replace the inlet filter 41.

In a third example, the maintenance signaling algorithm is based on a condition of power absorbed by the mechanical energy generation device 421, e.g., an electric motor. In this case, the current sensor 116 constantly monitors the current absorbed by the electric motor 421, detecting the value thereof and sending it to the control unit 120 which calculates the power absorbed by the electric motor 421 during the operation thereof. Generally, in fact, when the inlet filter 41 is too dirty, the electric motor 421 enters a malfunction condition, absorbing more or less power than that required for a correct operation.

The third maintenance signaling algorithm comprises the following steps:
setting a maximum value of power absorbed by the electric motor 421, above which the motor starts working in a malfunction condition;
detecting, by the current sensor 116, the current absorbed by the electric motor 421 and calculating the power absorbed by the motor;
when the power absorbed by the motor exceeds the maximum power value, activating the warning means 130 to notify the user of the need to clean and/or replace the inlet filter 41.

The examples of maintenance signaling algorithms implemented as described above cause the warning means 130 to turn on. It is also preferable to cause the warning means 130 to switch off by a switching-off mechanism.

In an embodiment, the switching off of the warning means 130 is automatically controlled by the control unit 120, and occurs at the end of a predefined maintenance interval. In fact, once the warning means 130 have been actuated, they remain active for a certain time interval, precisely the maintenance interval, to allow the user to remove the inlet filter 41 to clean and/or replace it. Preferably, the maintenance interval is between 30 seconds and 3 minutes. Still preferably, the maintenance interval time is equal to 2 minutes.

In an embodiment, the maintenance signaling system 100 comprises a filter position sensor 410 connected to the control unit 120. Such a position sensor 410 is suitable for detecting the displacement of the filter by the user, or to detect the coupling and/or uncoupling of the inlet filter to/from the seat 400 thereof. According to such an embodiment, the switching off of the warning means 130 occurs when the filter position sensor detects a position variation, or the coupling/uncoupling of the filter to/from the seat thereof.

In a further embodiment, the warning means 130 remain on until the user switches them off manually, by the user interface 22.

Innovatively, the hair dryer provided with the maintenance signaling system according to the present invention allows notifying the user when a maintenance operation on the inlet filter is required, overcoming the typical issues of the prior art.

Advantageously, the maintenance signaling system according to the present invention allows timely notifying the user of the dirty condition of the inlet filter, thus preventing sudden switch-offs of the hair dryer upon overheating.

Advantageously, the maintenance signaling system according to the invention ensures a safe and efficient operation of the hair dryer for both the user and the customer.

Advantageously, the hair dryer according to the present invention is provided with a simple and effective signaling system, without involving an excessive increase in the production costs and production times of the device as a whole. In other words, the maintenance signaling system according to the invention ensures simplicity of construction and, at the same time, efficiency in signaling.

It is apparent that, in order to meet contingent needs, those skilled in the art may make changes to the above-described invention, all contained in the scope of protection as defined by the following claims.

1. A hair dryer comprising an internally hollow body, which houses:
at least one air inlet filter, arranged in a filter seat;
an air flow generation group comprising a mechanical energy generation device which powers an air flow generation device;
at least one heating element for incoming air from the filter;
a maintenance signaling system of the inlet filter, comprising a control unit which manages activation means of warning means.

2. The hair dryer according to claim 1, wherein said warning means comprise at least one LED, visible from outside the hollow body.

3. The hair dryer according to claim 1, wherein said warning means are sound means which produce a sound signal, audible from outside the hollow body.

4. The hair dryer according to claim 1, wherein the activation means comprises a time counter which measures an operating time interval of the hair dryer.

5. The hair dryer according to claim 4, wherein said maintenance signaling system implements the following maintenance signaling algorithm:
setting a maximum time interval;
starting the time counter which measures the operating time interval;
when the operating time interval reaches the maximum time interval, activating the warning means.

6. The hair dryer according to claim 5, wherein the maximum time interval is between 20 and 30 hours.

7. The hair dryer according to claim 1, wherein the activation means comprise at least one temperature sensor which detects the temperature of air heated by the heating element inside the hollow body.

8. The hair dryer according to claim 7, wherein said maintenance signaling system implements the following maintenance signaling algorithm:
setting a maximum internal air temperature value;
detecting, by the temperature sensor, the temperature of the air heated by the heating element;
if the air temperature is greater than the maximum temperature value, activating the warning means.

9. The hair dryer according to claim 7, wherein the temperature sensor is a negative temperature coefficient (NTC) sensor.

10. The hair dryer according to claim 1, wherein the activation means comprise at least one current sensor which measures absorbed current of the mechanical energy generation device.

11. The hair dryer according to claim 10, wherein said maintenance signaling system implements the following maintenance signaling algorithm:
setting a maximum value of power absorbed by the electric motor;
detecting, by the current sensor, the current absorbed by the electric motor and calculating the power absorbed by the motor;
when the power absorbed by the motor exceeds the maximum power value, activating the warning means.

12. The hair dryer according to claim 1, wherein the mechanical energy generation device is an electric motor.

13. The hair dryer according to claim 5, wherein the maximum time interval comprises 25 hours.
